(19) United States
(12) Patent Application Publication
(10) Pub. No.: US 2026/0348845 A1
(43) Pub. Date: Nov. 5, 2026

(54) SPECTRAL SENSING DEVICE AND METHOD OF DETERMINING AT LEAST ONE RELATIVE TIME-CORRECTED DETECTOR SIGNAL OF AT LEAST ONE SAMPLE

(71) Applicant: TRINAMIX GMBH, Ludwigshafen am Rhein (DE)

(72) Inventors: Robert LOVRINCIC, Ludwigshafen am Rhein (DE); Michael HANKE, Muenchen (DE)

(21) Appl. No.: 19/491,074

(22) PCT Filed: Jun. 21, 2024
(86) PCT No.: PCT/EP2024/067405

§ 371 Date: Dec. 8, 2025

(30) Foreign Application Priority Data
Jun. 22, 2023 (EP) 23181065.6

(51) Int. Cl. G01N 21/359

(52) U.S. Cl. CPC G01N 21/359; G01N 2201/022

(57) ABSTRACT

Disclosed herein is a spectral sensing device, including:
at least one first light source configured for emitting light in at least one first optical spectral range and at least one second light source configured for emitting light in at least one second optical spectral range;
at least one detector including a plurality of sensor elements;
at least one sample interface configured for allowing light emitted from the first light source to illuminate at least one sample;
at least one first optical path configured for allowing light emitted from the first light source to propagate to the detector by passing the sample interface at least once; and
at least one second optical path allowing light emitted from the second light source to propagate to the detector without passing the sample interface.
   Further disclosed herein is a method of determining at least one relative time-corrected detector signal.

### TECHNICAL FIELD

The invention relates to a spectral sensing device and to a method of determining at least one relative time-corrected detector signal of at least one sample. The invention further relates to a computer program and a computer-readable storage medium. Such devices and methods can, in general, be used for investigating or monitoring purposes, in particular, in the infrared (IR) spectral region, especially in the near-infrared (NIR) spectral region, and in the visible (VIS) spectral region, e.g. in a spectral region allowing to mimic a human's ability of color sight. However, further applications are feasible.

### BACKGROUND ART

Spectral sensing device, such as spectrometer devices, are known to be efficient tools for obtaining information on the spectral properties of an object, when emitting, irradiating, reflecting and/or absorbing light. Spectral sensing devices, thus, may assist in analyzing samples or other tasks in which information on the spectral properties of an object is of interest. The spectral information may generally be obtained via one or more detectors and one or more wavelengthselective optical elements, such as one or more dispersive optical elements, filters such as bandpass filters, prisms, gratings, interferometers, or the like.

U.S. Pat. No. 9,360,366 B1 discloses a self-referencing spectrometer that simultaneously auto-calibrate and measure optical spectra of physical object utilizing shared aperture as optical inputs. The concurrent measure and self-calibrate capabilities makes it possible as an attachment spectrometer on a mobile computing device without requiring an off-line calibration with an external reference light source. Through the mobile computing device, the obtained spectral information and imagery captured can be distributed through the wireless communication networks.

WO 2022/117611 A1 discloses a spectral sensing device and a method for measuring optical radiation. The spectral sensing device comprises: at least one photosensitive detector, wherein the at least one photosensitive detector has at least one photosensitive region designated for receiving optical radiation, wherein at least one detector signal as generated by the at least one photosensitive detector is dependent on an illumination of the at least one photosensitive region; at least one radiation emitting element, wherein the at least one radiation emitting element is designated for emitting the optical radiation; at least one optical element, wherein the at least one optical element is designated to guide a first portion of the optical radiation to the at least one photosensitive detector; at least one evaluation unit, wherein the at least one evaluation unit is configured to perform a calibration of the spectral sensing device by using at least one first detector signal as generated by the at least one photosensitive detector upon the illumination of the at least one photosensitive region by the first portion of the optical radiation, wherein the calibration refers to a process of correcting from time to time drifting effects occurring in the spectral sensing device, wherein the drifting effects are caused by alterations related to the spectral sensing device itself or having an effect onto the spectral sensing device. The spectral sensing device and a method for measuring optical radiation are configured to perform, preferably in a fully automatized fashion, a self-calibration of the spectral sensing device without requiring any predefined reflection target. Thus, the spectral sensing device and the method may, specifically, be configured for performing a self-calibration without user involvement.

Many spectral sensing devices may comprise multiple detectors, e.g. spectrometer devices based on linear array detectors. In these devices, a measured observable of a sample, e.g. an absorption spectrum of the sample, is often calculated by referencing a sample measurement to a reference spectrum, i.e. by dividing the sample measurement by a reference measurement to obtain the sample spectrum. This measurement procedure may allow to eliminate any influence of the measurement setup on the sample spectrum, specifically under the assumption that the properties of the measurement setup did not change in the time between reference measurement and sample measurement. However, most spectral sensing devices are not perfectly stable in time and, thus, artefacts may be introduced in the sample spectrum that do not carry any information about the sample.

### PROBLEM TO BE SOLVED

It is therefore desirable to provide methods and devices, which at least partially address the above-mentioned technical challenges and at least substantially avoid the disadvantages of known methods and devices. In particular, it is an object of the present invention to provide a spectral sensing device and a method of determining at least one relative time-corrected detector signal of at least one sample which allow at least partial correction and/or compensation of artefacts.

### SUMMARY

This problem is addressed by a spectral sensing device, a method of determining at least one relative time-corrected detector signal of at least one sample, a computer program and a computer-readable storage medium, with the features of the independent claims. Advantageous embodiments which might be realized in an isolated fashion or in any arbitrary combinations are listed in the dependent claims as well as throughout the specification.

In a first aspect of the present invention, a spectral sensing device is disclosed. The term “spectral sensing device” as used herein is a broad term and is to be given its ordinary and customary meaning to a person of ordinary skill in the art and is not to be limited to a special or customized meaning. The term specifically may refer, without limitation, to an optical device configured for acquiring at least one item of optical information on at least one sample. For example, the spectral sensing device may be an optical device configured for determining and/or detecting and/or sensing the sample, such as a 3D-detector. The spectral sensing device may be or may comprise at least one spectrometer device. For example, the spectral sensing device may be an optical device configured for acquiring at least one item of spectral information on the sample. Specifically, the at least one item of spectral information may refer to at least one optical property or optically measurable property which is determined as a function of a wavelength, for one or more different wavelengths. More specifically, the optical property or optically measurable property, as well as the at least one item of spectral information, may relate to at least one property characterizing at least one of a transmission, an absorption, a reflection and an emission of the sample, either by itself or after illumination with external light. The at least one optical property may be determined for one or more wavelengths. The spectral sensing device specifically may form an apparatus which is capable of recording a signal intensity with respect to the corresponding wavelength of a spectrum or a partition thereof, such as a wavelength interval, wherein the signal intensity may, specifically, be provided as an electrical signal which may be used for further evaluation.

The spectral sensing device may specifically be a portable spectral sensing device, e.g. a portable spectrometer device. The term “portable” as used herein is a broad term and is to be given its ordinary and customary meaning to a person of ordinary skill in the art and is not to be limited to a special or customized meaning. The term specifically may refer, without limitation, to the property of at least one object of being moved by human force, such as by a single user. Specifically, the object characterized by the term “portable” may have a weight not exceeding 10 kg, specifically not exceeding 5 kg, more specifically not exceeding 1 kg or even not exceeding 500 g. Additionally or alternatively, the dimensions of the object characterized by the term “portable” may be such that the object extends by no more than 0.3 m into any dimension, specifically by no more than 0.2 m into any dimension. The object, specifically, may have a volume of no more than 0.03 m³, specifically of no more than 0.01 m³, more specifically no more than 0.001 m³ or even no more than 500 mm³. In particular, as an example, the portable spectral sensing device may have dimensions of e.g. 10 mm by 10 mm by 5 mm. Specifically, the portable spectral sensing device may be part of a mobile device, specifically a mobile communication device, or may be attachable to a mobile device, specifically a mobile communication device, such as a notebook computer, a tablet, a cell phone, such as a smart phone, a smartwatch and/or a wearable computer, also referred to as “wearable”, e.g. a body borne computer, such as a wrist band or a watch. In particular, the weight of the spectral sensing device, specifically of the portable spectral sensing device, may be in the range from 1 g to 100 g, more specifically in the range from 1 g to 10 g.

The spectral sensing device may be a near-infrared spectrometer, specifically a portable nearinfrared spectrometer. Thus, specifically, the spectral sensing device may be configured for acquiring the at least one item of spectral information on the sample in a wavelength range at least partially comprising the near-infrared spectral range, as will be outlined in further detail below.

The spectral sensing device comprises:
at least one first light source configured for emitting light in at least one first optical spectral range and at least one second light source configured for emitting light in at least one second optical spectral range;
at least one detector comprising a plurality of sensor elements, wherein each of the sensor elements is configured for generating at least one detector signal in response to an illumination of the sensor element by incident light;
at least one sample interface configured for allowing light emitted from the first light source to illuminate at least one sample;
at least one first optical path configured for allowing light emitted from the first light source to propagate to the detector by passing the sample interface at least once; and
at least one second optical path allowing light emitted from the second light source to propagate to the detector without passing the sample interface,
wherein the second light source is positioned to illuminate each of the sensor elements with the entire second optical spectral range.

The term “light source” as used herein is a broad term and is to be given its ordinary and customary meaning to a person of ordinary skill in the art and is not to be limited to a special or customized meaning. The term specifically may refer, without limitation, to an arbitrary device configured for generating or providing light. The light source specifically may be or may comprise at least one electrical light source, such as an electrically driven light source. As further used herein, the term “light” as used herein is a broad term and is to be given its ordinary and customary meaning to a person of ordinary skill in the art and is not to be limited to a special or customized meaning. The term specifically may refer, without limitation, to electromagnetic radiation in one or more of the infrared, the visible and the ultraviolet spectral range. Consequently, the term “optical spectral range”, as used herein, may refer, without limitation, to at least one wavelength interval at least partially comprising one or more of the infrared, the visible and the ultraviolet spectral range. Herein, the term “ultraviolet spectral range”, generally, refers to electromagnetic radiation having a wavelength of 1 nm to 380 nm, preferably of 100 nm to 380 nm. Further, in partial accordance with standard ISO-21348 in a valid version at the date of this document, the term “visible spectral range”, generally, refers to a spectral range of 380 nm to 760 nm. The term “infrared spectral range” (IR) generally refers to electromagnetic radiation of 760 nm to 1000 μm, wherein the range of 760 nm to 1.5 μm is usually denominated as “near infrared spectral range” (NIR), while the range from 1.5 μto 15 μm is denoted as “mid infrared spectral range” (MidIR) and the range from 15 μm to 1000 μm as “far infrared spectral range” (FIR). Preferably, light used for the typical purposes of the present invention is light in the infrared (IR) spectral range, more preferred, in the near infrared (NIR) and/or the mid infrared spectral range (MidIR), especially the light having a wavelength of 1 μm to 5 μm, preferably of 1 μm to 3 μm. This is due to the fact that many material properties or properties on a chemical constitution of many objects may be derived from the near infrared spectral range. It shall be noted, however, that spectroscopy in other spectral ranges is also feasible and within the scope of the present invention.

The terms “first” and “second”, as used herein, e.g. in the context of the first and second light source and/or in the context of the first and second optical path, generally, are used for nomenclature only, without implying any ranking or numbering. Thus, the presence of at least one first object or element and at least one second object or element may not restrict the possibility of having one or more further objects or elements of similar kind. Further, the first object or element may be embodied similar or different from the second object or element.

Each of the first light source and the second light source may comprise at least one light source selected from the group consisting of: a thermal emitter; an incandescent lamp; an arc lamp; a fluorescent lamp; a light emitting diode (LED); a laser; a laser diode; a solid-state laser; a gas laser; a quantum cascade laser; a plasma light source. For example, the first light source may comprise at least one incandescent lamp and the second light source may comprise at least one light emitting diode (LED). In this example, the first optical spectral range may be different from the second optical spectral range. However, it may also be possible to have the first optical spectral range different from the second optical range by using a first-colored LED as the first light source and a second-colored LED as the second light source, wherein the first color may be different from the second color. Other combinations or options of the first and second light sources are also feasible.

The term “detector” as used herein is a broad term and is to be given its ordinary and customary meaning to a person of ordinary skill in the art and is not to be limited to a special or customized meaning. The term specifically may refer, without limitation, to an arbitrary device configured for detecting, i.e. for at least one of determining, measuring and monitoring, at least one parameter, qualitatively and/or quantitatively, such as at least one of a physical parameter, a chemical parameter and a biological parameter. The detector may be configured for generating at least one detector signal, more specifically at least one electrical detector signal, such as an analogue and/or a digital detector signal, the detector signal providing information on the at least one parameter measured by the detector. The detector signal may directly or indirectly be provided by the detector to at least one evaluation unit, such that the detector and the evaluation unit may be directly or indirectly connected. The detector signal may be used as a “raw” detector signal and/or may be processed or preprocessed before further used, e.g. by filtering and the like. Thus, the detector may comprise at least one processing device and/or at least one preprocessing device, such as at least one of an amplifier, an analogue/digital converter, an electrical filter and a Fourier transformation.

The detector may comprise a plurality of optically sensitive elements or areas, also referred to as “sensor elements”. The plurality of sensor elements may comprise two or more sensor elements. The detector may be or may comprise at least one array of sensor elements, as will be outlined in further detail below. Each of the sensor elements may comprise at least one photosensitive area which may be adapted for generating an electrical signal depending on the intensity of the incident light, wherein the electrical signal may, in particular, be provided to an evaluation unit, as will be outlined in further detail below. The photosensitive area as comprised by each of the sensor elements may, especially, be a single, uniform photosensitive area which is configured for receiving the incident light which impinges on the individual sensor element. However, other arrangements of the optically sensitive elements may also be conceivable.

Each of the sensor elements may comprise at least one photosensitive material, specifically at least one photosensitive material selected from the group consisting of: lead sulfide (PbS); lead selenide (PbSe); mercury cadmium telluride (HgCdTe); cadmium sulfide (CdS); cadmium selenide (CdSe); indium antimonide (InSb); indium arsenide (InAs); indium gallium arsenide (InGaAs); silicon (Si); germanium (Ge); silicon germanium (SiGe); gallium arsenide (GaAs).

The sensor element, in particular the array of sensor elements, may be designed to generate detector signals, preferably electronic signals, associated with the intensity of the incident light which impinges on the individual sensor elements. The detector signal may be an analogue and/or a digital signal. The electronic signals for adjacent pixelated sensors can, accordingly, be generated simultaneously or else in a temporally successive manner. By way of example, during a row scan or line scan, it is possible to generate a sequence of electronic signals which correspond to the series of the individual sensor elements which are arranged in a line. In addition, the individual sensor elements may, preferably, be active pixel sensors which may be adapted to amplify the electronic signals prior to providing it to the evaluation unit. For this purpose, the detector may comprise one or more signal processing devices, such as one or more filters and/or analogue-digital-converters for processing and/or preprocessing the electronic signals.

In case the detector comprises an array of sensor elements, the detector, as an example, may be selected from any known pixel sensor, in particular, from a pixelated organic camera element, preferably, a pixelated organic camera chip, or from a pixelated inorganic camera element, preferably, a pixelated inorganic camera chip, more preferably from a CCD chip or a CMOS chip, which are, commonly, used in various cameras nowadays. Each of the sensor elements may comprise at least one element selected from the group consisting of: a photoconductor; a photodiode; a photocell; a photosensitive resistor; a phototransistor; a thermophile sensor; a photoacoustic sensor; a pyroelectric sensor; a photomultiplier; a bolometer. For example, the detector generally may be or comprise a photoconductor, in particular an inorganic photoconductor, especially PbS, PbSe, Ge, InGaAs, ext. InGaAs, InSb, or HgCdTe. As a further alternative, it may comprise at least one of pyroelectric, bolometer or thermophile detector elements.

Thus, a camera chip having a matrix of 1×N pixels or of M×N pixels may be used here, wherein, as an example, M may be less than 10 and N may be in the range from 1 to 50, preferably from 2 to 20, more preferred from 5 to 10. Further, a monochrome camera element, preferably a monochrome camera chip, may be used, wherein the monochrome camera element may be differently selected for each optically sensitive element, especially, in accordance with the varying wavelength along the series of the optical sensors.

Thus, the array may be adapted to provide a plurality of the electrical signals which may be generated by the photosensitive areas of the optically sensitive elements comprised by the array. The electrical signals as provided by the array of the spectrometer device may be forwarded to the evaluation unit.

The term “illumination” as used herein is a broad term and is to be given its ordinary and customary meaning to a person of ordinary skill in the art and is not to be limited to a special or customized meaning. The term specifically may refer, without limitation, to an amount or an intensity of light impinging a certain area, specifically a photosensitive area of the sensor elements.

The term “sample interface” as used herein is a broad term and is to be given its ordinary and customary meaning to a person of ordinary skill in the art and is not to be limited to a special or customized meaning. The term specifically may refer, without limitation, to a boundary of the spectral sensing device through which light in the optical spectral range, such as in at least one partition of the optical spectral range or in the full optical spectral range, may enter the spectral sensing device, specifically for the purpose of the spectral sensing, and/or may leave the spectral sensing device, e.g. for the purpose of illuminating the at least one sample. The sample interface, as an example, may define an optical plane, e.g. a plane either material or imaginary, of the spectral sensing device, through which the light from the first optical path, as will be explained in further detail below, may travel to reach the sample and/or through which the reflected light from the sample may travel to reach the detector, e.g. to generate a detector signal. The sample interface may or may not be constituted by a physical element and/or barrier, such as a transparent element, e.g. a glass or quartz window. The sample interface may also be the sample surface itself or a plane where the sample can be placed or aligned. As an example, the sample interface may be or may comprise at least one element comprising at least one transparent material being at least partially transparent in the optical spectral range, such as in at least one partition of the optical spectral range or in the full optical spectral range. The sample interface may be configured for transmitting light in the optical spectral range. The sample interface may be arranged in an optical path of the sensing device, specifically in the first optical path, to allow light emitted from the light source to illuminate a sample placed in front of the spectral sensing device, specifically in front of the sample interface. The transparent material may, as an example, comprise one or more of a glass material, such as silica, soda lime, borosilicate or the like, and/or a polymeric material, such as polymethylmethacrylate or polystyrene.

The term “sample” as used herein is a broad term and is to be given its ordinary and customary meaning to a person of ordinary skill in the art and is not to be limited to a special or customized meaning. The term specifically may refer, without limitation, to an arbitrary object or element, chosen from a living object or a non-living object, and having at least one optical property, the determination of the optical property, preferably, being of interest to a user when using the spectral sensing device. The sample may be suitable for interfacing with the spectral sensing device, specifically with the sample interface.

As outlined above, the spectral sensing device further comprises the at least one first optical path configured for allowing light emitted from the first light source to propagate to the detector by passing the sample interface at least once and the at least one second optical path allowing light emitted from the second light source to propagate to the detector without passing the sample interface.

The term “optical path” as used herein is a broad term and is to be given its ordinary and customary meaning to a person of ordinary skill in the art and is not to be limited to a special or customized meaning. The term specifically may refer, without limitation, to a trajectory of light in the spectral sensing device. The optical path of light in the spectral sensing device may be affected by reflection, refraction, dispersion and/or absorption at one or more optical elements, such as lenses, prisms, mirrors, gratings or the like, comprised by the spectral sensing device.

The term “first optical path” as used herein is a broad term and is to be given its ordinary and customary meaning to a person of ordinary skill in the art and is not to be limited to a special or customized meaning. The term specifically may refer, without limitation, to an optical path with sample interaction. Specifically, a detector signal obtained via the first optical path may be affected from a presence and/or an absence of the sample at the spectral sensing device. For example, a detector signal obtained via the first optical path having the sample applied to the sample interface may be different from a detector signal obtained via the first optical path having no sample applied to the sample interface, specifically irrespective of constant environmental conditions. In particular, the first optical path may be configured for allowing light emitted from the first light source to propagate, optionally via a wavelength-selective element, to the detector by passing the sample interface at least once. For example, the first optical path may allow light emitted from the first light source to propagate to the sample interface and, subsequently to the detector, optionally via a wavelength-selective element. Via the first optical path, light emitted from the first light source may be guided directly or indirectly, such as by reflection, refraction and/or dispersion, to the sample interface. The first optical path may be partially arranged outside the spectral sensing device, such as outside a housing of the spectral sensing device. Specifically, light in the first optical path may leave the spectral sensing device, in particular a housing of the spectral sensing device, at the sample interface to illuminate the sample arranged outside the spectral sensing device. The first optical path may be configured for coupling light reflected at the sample back into the spectral sensing device. Light reflected at the sample interface may be guided directly or indirectly, such as by reflection, refraction and/or dispersion, to the detector, optionally by passing a wavelength-selective element. The reflection at the sample interface may comprise a diffuse reflection. Specifically, light in the first optical path illuminating the detector may be diffusively reflected light. The detector may be configured for generating at least one detector signal in response to an illumination by incident light via the first optical path, in the following also referred to as “first detector signal”.

The term “second optical path” as used herein is a broad term and is to be given its ordinary and customary meaning to a person of ordinary skill in the art and is not to be limited to a special or customized meaning. The term specifically may refer, without limitation, to an optical path without sample interaction. Specifically, a detector signal obtained via the second optical path may be unaffected from a presence and/or an absence of the sample at the spectral sensing device. For example, a detector signal obtained via the second optical path having the sample applied to the sample interface may be equal to a detector signal obtained via the second optical path having no sample applied to the sample interface, specifically assuming constant environmental conditions. In particular, the second optical path may be configured for allowing light emitted from the second light source to propagate to the detector without passing the sample interface, specifically without being reflected at the sample. For example, via the second optical path, light emitted from the second light source may be passed to the detector without interacting with the sample. The second optical path may be arranged completely in the spectral sensing device, such as within a housing of the spectral sensing device. Light following the second optical path may be emitted by the second light source and may be directly or indirectly, such as by reflection, refraction and/or dispersion, guided to the detector. As an example, the second optical path may comprise a direct illumination of the detector. Alternatively or additionally, the second optical path may comprise at least one reflection at one or more optical elements of the spectral sensing device, specifically such that reflected light may illuminate the detector. Alternatively or additionally, the second optical path may be or may comprise a fiber-coupled optical path transferring light from the second light source to the detector. The detector may be configured for generating at least one detector signal in response to an illumination by incident light via the second optical path, in the following also referred to as “second detector signal”.

As further outlined above, the second light source is positioned to illuminate each of the sensor elements with the entire second optical spectral range. The term “entire second optical spectral range” as used herein is a broad term and is to be given its ordinary and customary meaning to a person of ordinary skill in the art and is not to be limited to a special or customized meaning. The term specifically may refer, without limitation, to a complete optical spectral range as emitted by the second light source. Specifically, the entire second optical spectral range may be identical, at least within certain tolerances, with the second optical spectral range as emitted by the second light source. The tolerances may refer to one or both of intensity and wavelength range. For example, the entire second optical spectral range may refer to a partition of the second optical spectral range from a first wavelength to a second wavelength as long as each of the sensor elements may be illuminated by the same partition. The entire second optical spectral range on each sensor element may, as an example, be obtained by avoiding passing the light emitted by the second light source through a wavelength-selective element. As an example, the second light source may be positioned to directly illuminate the detector. Other examples are also feasible, as will be outlined in further detail below.

The second light source may specifically be configured such that an intensity incident on each of the sensor elements has the same scaling factor with time. The term “scaling factor” as used herein is a broad term and is to be given its ordinary and customary meaning to a person of ordinary skill in the art and is not to be limited to a special or customized meaning. The term specifically may refer, without limitation, to at least one quantity describing a relation between an input and an output. The scaling factor of a light source, specifically of an intensity of the light source, may comprise an intrinsic relation for that light source. Specifically, the scaling factor may describe a relation between an applied electrical power, voltage or current to the light and a generated intensity of light by the light source. The scaling factor of a light source may vary in one or more of time and space. The second light source may have a constant spatial scaling factor. Thus, as an example, the second light source may be configured to illuminate each sensor element with the same spatial intensity distribution of light, specifically irrespective of the applied electrical power, voltage or current. As another example, the second light source may be configured to illuminate each sensor element with different spatial intensity distributions, but a relative spatial intensity distribution between all detector elements is constant in time.

The spectral sensing device may further comprise at least one evaluation unit. The term “evaluation unit” as used herein is a broad term and is to be given its ordinary and customary meaning to a person of ordinary skill in the art and is not to be limited to a special or customized meaning. The term specifically may refer, without limitation, to an arbitrary device or a combination of devices configured to evaluate or process at least one first item of information in order to generate at least one second item of information thereof. Thus, specifically, the evaluation unit may be configured for processing at least one input signal and to generate at least one output signal thereof. The at least one input signal, as an example, may comprise at least one detector signal provided directly or indirectly by the at least one detector. The output signal generated by evaluation or processing, as an example, may comprise a first detector signal for an illumination in the first optical path and a second detector signal for an illumination in the second optical path.

As an example, the evaluation unit may be or may comprise one or more integrated circuits, such as one or more application-specific integrated circuits (ASICs), and/or one or more data processing devices, such as one or more of computers, digital signal processors (DSP), field programmable gate arrays (FPGA) preferably one or more microcomputers and/or microcontrollers. Additional components may be comprised, such as one or more preprocessing devices and/or data acquisition devices, such as one or more devices for receiving and/or preprocessing of the detector signals, such as one or more AD-converters and/or one or more filters. Further, the evaluation unit may comprise one or more data storage devices. Further, the evaluation unit may comprise one or more interfaces, such as one or more wireless interfaces and/or one or more wire-bound interfaces.

The evaluation unit may be adapted to execute at least one computer program, such as at least one computer program performing or supporting the step of generating the items of information. As an example, one or more algorithms may be implemented which, by using the at least one detector signal may perform a predetermined transformation for correcting the detector signal and, optionally for further deriving spectroscopic information on the sample, such as for deriving a corrected spectrum and/or for deriving at least one spectroscopic information describing at least one property of the sample. For this purpose, the evaluation unit may, particularly, comprise at least one data processing device, also referred to as a processor, in particular an electronic data processing device, which can be designed to generate the desired information by evaluating the detector signal. The evaluation unit may use an arbitrary process for generating the required information, such as by calculation and/or using at least one stored and/or known relationship. The evaluation unit specifically may be configured for performing at least one digital signal processing (DSP) technique on a primary o raw detector signal, in particular at least one Fourier transformation. Additionally or alternatively, the evaluation unit may be configured for performing one or more further digital signal processing techniques on the primary detector signal, e.g. windowing, filtering, Goertzel algorithm, crosscorrelation or autocorrelation. Besides the detector signal one or a plurality of further parameters and/or items of information can influence said relationship. The relationship can be determined or determinable empirically, analytically or else semi-empirically. As an example, the relationship may comprise at least one of a model or calibration curve, at least one set of calibration curves, at least one function or a combination of the possibilities mentioned. One or a plurality of calibration curves can be stored for example in the form of a set of values and the associated function values thereof, for example in a data storage device and/or a table. Alternatively or additionally, however, the at least one calibration curve can also be stored for example in parameterized form and/or as a functional equation. Separate relationships for processing the detector signals into the items of information may be used. Alternatively, at least one combined relationship for processing the detector signals is feasible. Various possibilities are conceivable and can also be combined.

The evaluation unit may be configured for determining at least one first detector signal S_{1,i} from illumination in the first optical path, specifically at least one first detector signal S_{1,i} for each sensor element i, and at least one second detector signal S_{2,i} from illumination in the second optical path, specifically at least one second detector signal S_{2,i} for each sensor element i. The evaluation unit may further be configured for determining at least one relative time-corrected detector signal S_{1,i,corr} and/or at least one absolute time-corrected detector signal S_{1,i,corr,t-corr} by using the first detector signal S_{1,i} and the second detector signal S_{2,i}, specifically by performing the method according to the present invention, such as according to any one of the embodiments disclosed in further detail below.

For example, the first light source and the second light source may be configured for emitting light at the same time, specifically simultaneously, or subsequently in time, wherein at least one of the first light source and the second light source may be modulated in time. Specifically, the spectral sensing device may further comprise at least one driving unit for electrically driving at least one of the first light source and the second light source. The term “to drive” as used herein is a broad term and is to be given its ordinary and customary meaning to a person of ordinary skill in the art and is not to be limited to a special or customized meaning. The term specifically may refer, without limitation, to the process of providing one or both of at least one control parameter and/or electrical power to another device. The term “driving unit” as used herein is a broad term and is to be given its ordinary and customary meaning to a person of ordinary skill in the art and is not to be limited to a special or customized meaning. The term specifically may refer, without limitation, to an arbitrary device or a combination of devices configured for providing one or both of at least one control parameter and/or electrical power to another device, such as, in the present case, to at least one of the first light source and second light source. For example, the driving unit may comprise at least one current source for providing at least one predetermined current to at least one of the first light source and second light source, wherein the current source specifically may be configured for adjusting or controlling a voltage applied to at least one of the first light source and second light source in order to generate the predetermined current. The driving unit, as an example, may comprise one or more electrical components, such as integrated circuits, for driving at least one of the first light source and second light source. The driving unit may fully or partially be integrated into the first light source and/or the second light source or may be separated from the first light source and/or second light source.

As an example, both the first light source and the second light source may be modulated in time with at least one first modulation frequency and at least one second modulation frequency, respectively. The first modulation frequency may be different from the second modulation frequency. The evaluation device may be configured for determining the first detector signal and the second detector signal by demodulation, e.g. using a Fourier transformation.

The spectral sensing device may comprise at least one wavelength-selective element configured for transferring incident light within at least one selected wavelength range onto the detector. As used herein is a broad term and is to be given its ordinary and customary meaning to a person of ordinary skill in the art and is not to be limited to a special or customized meaning. The term specifically may refer, without limitation, to an arbitrary optical element which interacts with differing spectral portions of incident light in a different manner, e.g. by having at least one wavelength-dependent optical property, such as at least one wavelength-dependent optical property selected from the list consisting of a degree of reflection, a direction of reflection, a degree of refraction, a direction of refraction, an absorption, a transmission, an index of refraction.

The wavelength-selective element, specifically may be selected from the group of a tunable wavelength-selective element and a wavelength-selective element having a fixed transmission spectrum. By using a tunable wavelength-selective element, as an example, differing wavelength ranges may be selected sequentially, whereas, by using a wavelength-selective element having a fixed transmission spectrum, the selection of the wavelength ranges may be fixed and may, however, be dependent e.g. on a detection position, thereby allowing, as an example, for simultaneously exposing different detectors and/or different sensor elements of the detector to differing spectral ranges of light.

The wavelength-selective element may comprise at least one of a filter, a grating, a prism, a plasmonic filter, a diffractive optical element and a metamaterial. The wavelength-selective element may comprise one or more of a dispersive (e.g. prism), or diffractive (grating) element, or a detector with an inherently limited bandwidth of its spectral response. Additionally or alternatively, the wavelength-selective element may comprise at least one of the following elements: an array of individual bandpass filters, an array of patterned filters, a MEMS-Interferometer, a MEMS-Fabry Perot interferometer. Further elements are feasible.

The wavelength-selective element may be positioned in the first optical path, specifically with wavelength-dependent transfer of light in the first optical path at the wavelength-selective element. For example, the spectral sensing device may comprise at least one filter element disposed in the first optical path, wherein the filter element, specifically may be configured such that each of the sensor elements is exposed to an individual spectral range of the light from the sample. As an example, a variable filter element may be used, the transmission of which depends on a position on the filter element, such that, when the variable filter element is placed on top of the array of sensor elements, the individual sensor elements are exposed to differing spectral ranges of the incident light. In this case, having a filter element disposed on the sensor elements of the detector, the second optical path may ensure an illumination of the detector with light from the second light source not passing through the filter element.

For example, the second optical path may comprise at least one reflection at the wavelengthselective element, specifically without wavelength-dependent transfer of light in the second optical path at the wavelength-selective element. Alternatively or additionally, the detector and the second light source may be comprised by at least one housing. The housing may comprise at least one window element being optically transparent at least in the first optical spectral range. The window element may be positioned in the first optical path. The second light source may be positioned to illuminate the housing such that light emitted by the second light source is reflected by the housing and propagates to the detector, specifically without passing the wavelength-selective element. As an example, the detector and the second light source may be positioned in at least one stack, wherein, in the stack, the second light source may be positioned on a rear side of the detector, wherein the second light source may be positioned to emit light though the rear side of the detector towards the housing. In this configuration, the window element and the wavelength-selective element may be positioned on a front side of the detector.

In a further aspect of the present invention, a method of determining at least one relative timecorrected detector signal of at least one sample is disclosed. The method comprises using at least one spectral sensing device according to the present invention, such as according to any one of the embodiments disclosed above and/or according to any one of the embodiments disclosed in further detail below. Thus, for definitions of terms and possible embodiments of the spectral sensing device, reference is made to the description of the spectral sensing device.

The method comprises the following steps which, as an example, may be performed in the given order. It shall be noted, however, that a different order is also possible. Further, it is also possible to perform one, more than one or even all of the method steps once or repeatedly. Furthe, it is possible to perform two or more of the method steps simultaneously or in a timely overlapping fashion. The method may comprise further method steps which are not listed.

The method further comprises:
I. illuminating the detector via the first optical path using the first light source to obtain at least one first detector signal S_{1,i}, specifically at least one first detector signal S_{1,i} for each sensor element i, wherein the sample is applied to the sample interface;
II. illuminating the detector via the second optical path using the second light source to obtain at least one second detector signal S_{2,i}, specifically at least one second detector signal S_{2,i} for each sensor element i; and
III. determining the relative time-corrected detector signal by using the first detector signal S_{1,i} and the second detector signal S_{2,i}.

The term “relative” as used herein is a broad term and is to be given its ordinary and customary meaning to a person of ordinary skill in the art and is not to be limited to a special or customized meaning. The term specifically may refer, without limitation, to a property of a first quantity of being expressed in relation, e.g. as a ratio, to a second quantity. The relative detector signal may specifically comprise, for each sensor element, the first detector signal in relation to the second detector signal. The relative detector signal may be corrected for temporal relative changes of the sensor elements, e.g. corrected for relative changes of a sensitivity of the sensor elements and/or relative changes of read-out electronics, and, thus, be referred to as “time-corrected”.

The relative time-corrected detector signal S_{1,i,corr} may be determined according to:

S_{1,i,corr}=S_{1,i}/S_{2,i}.

The first detector signal S_{1,i} may be proportional to an intensity of the first light source I_{1,i} on sensor element i with S_{1,i}=αᵢ(t)I_{1,i}. Similarly, the second detector signal S_{2,i} may be proportional to an intensity of the second light source I_{2,i} on sensor element i with S_{2,i}=αᵢ (t)I_{2,i}. αᵢ may denote a responsivity, specifically a sensitivity, of the sensor element i. The relative timecorrected detector signal S_{1,i,corr}=S_{1,i}/S_{2,i}=I_{1,i}/I_{2,i} may specifically be a constant with no timedependence for each sensor element i.

The method may further comprise determining at least one factorial drift factor γ according to:

$$γ = \frac{1}{N} {\sum }_{i = 1}^{N} {S}_{2 , i} ( t ) / {S}_{2 , i} ( {t}_{0} ) ,$$

wherein N may be a total number of the sensor elements, wherein I_{2,i}(t)=β(t)*I_{2,i}(t₀), with β(t₀)=1 at a starting point in time to.

Further, the method may comprise determining at least one absolute time-corrected detector signal S_{1,i,corr,t-corr} according to:

$${S}_{1 , i , corr , t - corr} = \frac{{S}_{1 , i , corr}}{γ} .$$

Further, as outlined above, the spectral sensing device may comprise the at least one evaluation unit. The method may comprise determining the at least one first detector signal S_{1,i} from illumination in the first optical path, specifically at least one first detector signal S_{1,i} for each sensor element i, and the at least one second detector signal S_{2,i} from illumination in the second optical path, specifically at least one second detector signal S_{2,i} for each sensor element i, by using the evaluation unit. The method may comprise, specifically in steps. I and II., emitting light using the first light source and the second light source at the same time, specifically simultaneously, or subsequently in time. For example, the spectral sensing device may further comprise at least one driving unit for electrically driving at least one of the first light source and the second light source. The modulating may comprise using the driving unit. The method may comprise modulating at least one of the first light source and the second light source in time. Specifically, the method may comprise modulating the first light source in time with at least one first modulation frequency and modulating the second light source in time with at least one second modulation frequency. The first modulation frequency may be different from the second modulation frequency. The method may comprise determining the first detector signal and the second detector signal by demodulation by using the evaluation unit.

In a further aspect of the present invention, a computer program is disclosed, comprising instructions which, when the computer program is executed by a spectral sensing device according to the present invention, specifically comprising at least one evaluation unit, cause the spectral sensing device to perform the method of determining at least one relative time-corrected detector signal of at least one sample according to the present invention, such as according to any one of the embodiments disclosed above and/or according to any other embodiment disclosed in further detail below.

In a further aspect of the present invention, a computer-readable storage medium, specifically a non-transient computer-readable storage medium, is disclosed, comprising instructions which, when the instructions are executed by a spectral sensing device according to the present invention, specifically comprising at least one evaluation unit, cause the spectral sensing device to perform the method of determining at least one relative time-corrected detector signal of at least one sample according to the present invention, such as according to any one of the embodiments disclosed above and/or according to any other embodiment disclosed in further detail below.

As used herein, the term “computer-readable storage medium” specifically may refer to nontransitory data storage means, such as a hardware storage medium having stored thereon computer-executable instructions. The computer-readable storage medium specifically may be or may comprise a storage medium such as a random-access memory (RAM) and/or a read-only memory (ROM).

Further disclosed and proposed herein is a computer program including computer-executable instructions for performing the method according to the present invention in one or more of the embodiments enclosed herein when the program is executed on a computer or computer network. Specifically, the computer program may be stored on a computer-readable data carrier and/or on a computer-readable storage medium.

Thus, specifically, one, more than one or even all of method steps I. to III. as indicated above may be performed by using a computer or a computer network, preferably by using a computer program.

Further disclosed and proposed herein is a computer program product having program code means, in order to perform the method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing the method according to one or more of the embodiments disclosed herein.

Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer, a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

The spectral sensing device and the method according to the present invention may provide a large number of advantages over known methods and devices. Specifically, the spectral sensing device and the method according to the present invention may allow for correcting temporal relative changes of the sensor element, e.g. relative changes of a sensitivity of the sensor element and/or relative changes of read-out electronics, by setting the first detector signal in relation to the second detector signal.

The spectral sensing device comprises the at least one first light source and the at least one second light source. The light emitted by the first light source may interacts with or originates from the sample or object under test (OuT). The light emitted by the second light source may not interact with or originate from the sample or object under test. The first and the second light may specifically be independent from each other. The spectral sensing device further comprises the detector comprising the plurality of sensor elements, optionally further comprising respective read-out electronics. The first light source and the second light source may illuminate the detector either subsequently in time, or the first light source and the second light source are modulated in time with the prerequisite that the first light source interacting with the OuT may be modulated at other frequencies than the second light sources not interacting with the OuT. The second light source illuminating the sensor elements may emit light not interacting with or originating from the OuT may be designed such that the intensity, specifically not the measured detector signal, incident on each sensor element has the same scaling factor with time. The spectral sensing device may optionally further comprises at least one wavelength-selective element.

As outlined above, by setting the first detector signal and the second detector signal generated by the sensor element into relation, the spectral sensing device and the method according to the present invention may allow for correcting temporal relative changes of the sensors, e.g. relative changes of a sensitivity of the sensor elements and/or relative changes of read-out electronics. The first detector signal registered by the sensor element i from the light from the OuT may be denoted S_{1,i}, whereas the second detector signal on the same sensor element from the light that did not interact or originate from the OuT may be denoted S_{2,i}, S_{1,i} and S_{2,i} may be proportional to the incident intensities S_{1,i}=αᵢ(t)I_{1,i}, and S_{2,i}=αᵢ(t)I_{2,i}, where αᵢ may denoted the sensor element's responsivity or sensitivity. The sensor element's responsivity or sensitivity may be a function of time and its magnitude and/or behavior over time may be distinct for detector element j≠i.

Using the first detector signal and the second detector signal, the relative time- and element-to-element variation may be removed by referencing the first detector signal to the second detector signal:

S_{1,i,corr}=S_{1,i}/S_{2,i}=I_{1,i}/I_{2,i}.

Since I_{2,i}/I_{2,j} may be constant by design, also S_{1,i,corr}/S_{1,j,corr} may be a constant with no time-dependence. In absolute values, the relative time-corrected detector signals may have the same time dependence S_{1,i,corr}~β(t), ∇i, where β(t) denotes the time-dependence of I₂: I_{2,i}(t)=β(t)*I_{2,i}(t₀), with β(t₀)=1. The factorial drift between the starting point in time t₀ and t may be approximated by determining the second detector signal S₂ at both times:

$$γ = \frac{1}{N} {\sum }_{i = 1}^{N} {S}_{2 , i} ( t ) / {S}_{2 , i} ( {t}_{0} )$$

Here, N may denote the number of sensor element in the detector. Then, the absolute time-corrected detector signal may be obtained via S_{1,i,corr,t-corr}=S_{1,i,corr}/γ. The absolute time-corrected detector signal may provide both an element-to-element- and a time-corrected absolute detector signal.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:

Embodiment 1: A spectral sensing device comprising
at least one first light source configured for emitting light in at least one first optical spectral range and at least one second light source configured for emitting light in at least one second optical spectral range;
at least one detector comprising a plurality of sensor elements, wherein each of the sensor elements is configured for generating at least one detector signal in response to an illumination of the sensor element by incident light;
at least one sample interface configured for allowing light emitted from the first light source to illuminate at least one sample;
at least one first optical path configured for allowing light emitted from the first light source to propagate to the detector by passing the sample interface at least once;
and
at least one second optical path allowing light emitted from the second light source to propagate to the detector without passing the sample interface,
wherein the second light source is positioned to illuminate each of the sensor elements with the entire second optical spectral range.

Embodiment 2: The spectral sensing device according to the preceding embodiment, wherein the second light source is configured such that an intensity incident on each of the sensor elements has the same scaling factor with time.

Embodiment 3: The spectral sensing device according to any one of the preceding embodiments, wherein the spectral sensing device is a near-infrared spectrometer, specifically a portable near-infrared spectrometer.

Embodiment 4: The spectral sensing device according to any one of the preceding embodiments, wherein each of the first light source and the second light source comprises at least one light source selected from the group consisting of: a thermal emitter; an incandescent lamp; an arc lamp; a fluorescent lamp; a light emitting diode (LED); a laser; a laser diode; a solid-state laser; a gas laser; a quantum cascade laser; a plasma light source.

Embodiment 5: The spectral sensing device according to any one of the preceding embodiments, wherein the first light source comprises at least one incandescent lamp and the second light source comprises at least one light emitting diode (LED).

Embodiment 6: The spectral sensing device according to any one of the preceding embodiments, wherein the first optical spectral range is different from the second optical spectral range.

Embodiment 7: The spectral sensing device according to any one of the preceding embodiments, wherein each of the sensor elements comprises at least one photosensitive material, specifically at least one photosensitive material selected from the group consisting of: lead sulfide (PbS); lead selenide (PbSe); mercury cadmium telluride (HgCdTe); cadmium sulfide (CdS); cadmium selenide (CdSe); indium antimonide (InSb); indium arsenide (InAs); indium gallium arsenide (InGaAs); silicon (Si); germanium (Ge); silicon germanium (SiGe); gallium arsenide (GaAs).

Embodiment 8: The spectral sensing device according to any one of the preceding embodiments, wherein each of the sensor elements comprises at least one element selected from the group consisting of: a photoconductor; a photodiode; a photocell; a photosensitive resistor; a phototransistor; a thermophile sensor; a photoacoustic sensor; a pyroelectric sensor; a photomultiplier; a bolometer.

Embodiment 9: The spectral sensing device according to any one of the preceding embodiments, further comprising at least one evaluation unit, wherein the evaluation unit is configured for determining at least one first detector signal S_{1,i} from illumination in the first optical path, specifically at least one first detector signal S_{1,i} for each sensor element i, and at least one second detector signal S_{2,i} from illumination in the second optical path, specifically at least one second detector signal S_{2,i} for each sensor element i.

Embodiment 10: The spectral sensing device according to the preceding embodiment, wherein the first light source and the second light source are configured for emitting light at the same time, specifically simultaneously, or subsequently in time, wherein at least one of the first light source and the second light source is modulated in time.

Embodiment 11: The spectral sensing device according to the preceding embodiment, further comprising at least one driving unit for electrically driving at least one of the first light source and the second light source.

Embodiment 12: The spectral sensing device according to any one of the two preceding embodiments, wherein both the first light source and the second light source are modulated in time with at least one first modulation frequency and at least one second modulation frequency, respectively.

Embodiment 13: The spectral sensing device according to the preceding embodiment, wherein the first modulation frequency is different from the second modulation frequency.

Embodiment 14: The spectral sensing device according to any one of the four preceding embodiments, wherein the evaluation device is configured for determining the first detector signal and the second detector signal by demodulation.

Embodiment 15: The spectral sensing device according to any one of the preceding embodiments, wherein the spectral sensing device comprises at least one wavelength-selective element configured for transferring incident light within at least one selected wavelength range onto the detector.

Embodiment 16: The spectral sensing device according to the preceding embodiment, wherein the wavelength-selective element is positioned in the first optical path, specifically with wavelength-dependent transfer of light in the first optical path at the wavelength-selective element.

Embodiment 17: The spectral sensing device according to any one of the two preceding embodiments, wherein the second optical path comprises at least one reflection at the wavelength-selective element, specifically without wavelength-dependent transfer of light in the second optical path at the wavelength-selective element.

Embodiment 18: The spectral sensing device according to any one of the preceding embodiments, wherein the second light source is positioned to directly illuminate the detector.

Embodiment 19: The spectral sensing device according to any one of the preceding embodiments, wherein the detector and the second light source are comprised by at least one housing, the housing comprising at least one window element being optically transparent at least in the first optical spectral range.

Embodiment 20: The spectral sensing device according to the preceding embodiment, wherein the window element is positioned in the first optical path.

Embodiment 21: The spectral sensing device according to any one of the two preceding embodiments, wherein the second light source is positioned to illuminate the housing such that light emitted by the second light source is reflected by the housing and propagates to the detector.

Embodiment 22: The spectral sensing device according to the preceding embodiment, wherein the detector and the second light source are positioned in at least one stack, wherein, in the stack, the second light source is positioned on a rear side of the detector, wherein the second light source is positioned to emit light though the rear side of the detector towards the housing.

Embodiment 23: A method of determining at least one relative time-corrected detector signal of
at least one sample, the method comprising using at least one spectral sensing device according to any one of the preceding embodiments, the method further comprising:
I. illuminating the detector via the first optical path using the first light source to obtain at least one first detector signal S_{1,i}, specifically at least one first detector signal S_{1,i} for each sensor element i, wherein the sample is applied to the sample interface;
illuminating the detector via the second optical path using the second light source to obtain at least one second detector signal S_{2,i}, specifically at least one second detector signal S_{2,i} for each sensor element i; and
III. determining the relative time-corrected detector signal by using the first detector signal S_{1,i} and the second detector signal S_{2,i}.

Embodiment 24: The method according to the preceding embodiment, wherein the relative time-corrected detector signal S_{1,i,corr} is determined according to:

S_{1,i,corr}=S_{1,i}/S_{2,i}.

Embodiment 25: The method according to the preceding embodiment, wherein the first detector signal S_{1,i} is proportional to an intensity of the first light source I_{1,i} on sensor element i with S_{1,i}=“(t)I_{1,i}, wherein the second detector signal S_{2,i} is proportional to an intensity of the second light source I_{2,i} on sensor element i with S_{2,i}=αᵢ (t)I_{2,i}, wherein ai denotes a responsivity, specifically a sensitivity, of the sensor element i.

Embodiment 26: The method according to the preceding embodiment, wherein the relative time-corrected detector signal S_{1,i,corr}=S_{1,i}/S_{2,i}=I_{1,i}/I_{2,i} is a constant with no time-dependence for each sensor element i.

Embodiment 27: The method according to any one of the two preceding embodiments, further comprising determining at least one factorial drift factor γ according to:

$$γ = \frac{1}{N} {\sum }_{i = 1}^{N} {S}_{2 , i} ( t ) / {S}_{2 , i} ( {t}_{0} ) ,$$

wherein N is a total number of the sensor elements, wherein I_{2,i}(t)=β(t)*I_{2,i}(t₀), with β(t₀)=1 at a starting point in time t₀.

Embodiment 28: The method according to the preceding embodiment, further comprising determining at least one absolute time-corrected detector signal S_{1,corr,t-corr} according to:

$${S}_{1 , i , corr , t - corr} = \frac{{S}_{1 , i , corr}}{γ} .$$

Embodiment 29: The method according to any one of the preceding method embodiments, the spectral sensing device further comprising at least one evaluation unit, wherein the method comprises determining the at least one first detector signal S_{1,i} from illumination in the first optical path, specifically at least one first detector signal S_{1,i} for each sensor element i, and the at least one second detector signal S_{2,i} from illumination in the second optical path, specifically at least one second detector signal S_{2,i} for each sensor element i, by using the evaluation unit.

Embodiment 30: The method according to the preceding embodiment, wherein the method comprises, specifically in steps. I and II., emitting light using the first light source and the second light source at the same time, specifically simultaneously, or subsequently in time, wherein the method comprises modulating at least one of the first light source and the second light source in time.

Embodiment 31: The method according to the preceding embodiment, the spectral sensing device further comprising at least one driving unit for electrically driving at least one of the first light source and the second light source, wherein the modulating comprises using the driving unit.

Embodiment 32: The method according to any one of the two preceding embodiments, wherein the method comprises modulating the first light source in time with at least one first modulation frequency and modulating the second light source in time with at least one second modulation frequency.

Embodiment 33: The method according to the preceding embodiment, wherein the first modulation frequency is different from the second modulation frequency.

Embodiment 34: The method according to any one of the three preceding embodiments, wherein the method comprises determining the first detector signal and the second detector signal by demodulation by using the evaluation unit.

Embodiment 35: A computer program comprising instructions which, when the computer program is executed by a spectral sensing device according to embodiment 13, cause the spectral sensing device to perform the method of determining at least one relative timecorrected detector signal of at least one sample according to any one of the preceding method embodiments.

Embodiment 36: A computer-readable storage medium, specifically a non-transient computerreadable storage medium, comprising instructions which, when the instructions are executed by a spectral sensing device according to embodiment 13, cause the spectral sensing device to perform the method of determining at least one relative time-corrected detector signal of at least one sample according to any one of the preceding method embodiments.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the FIGS. Therein, identical reference numbers in these Figures refer to identical or functionally comparable elements.

In the Figures:

FIGS. 1 to 4 shows different, schematic embodiments of a spectral sensing device;

FIG. 5 shows a flow chart of an embodiment of a method of determining at least one relative time-corrected detector signal of at least one sample; and

FIG. 6 shows a diagram comparing relative time-corrected detector signals with uncorrected detector signals.

### DETAILED DESCRIPTION OF THE EMBODIMENTS

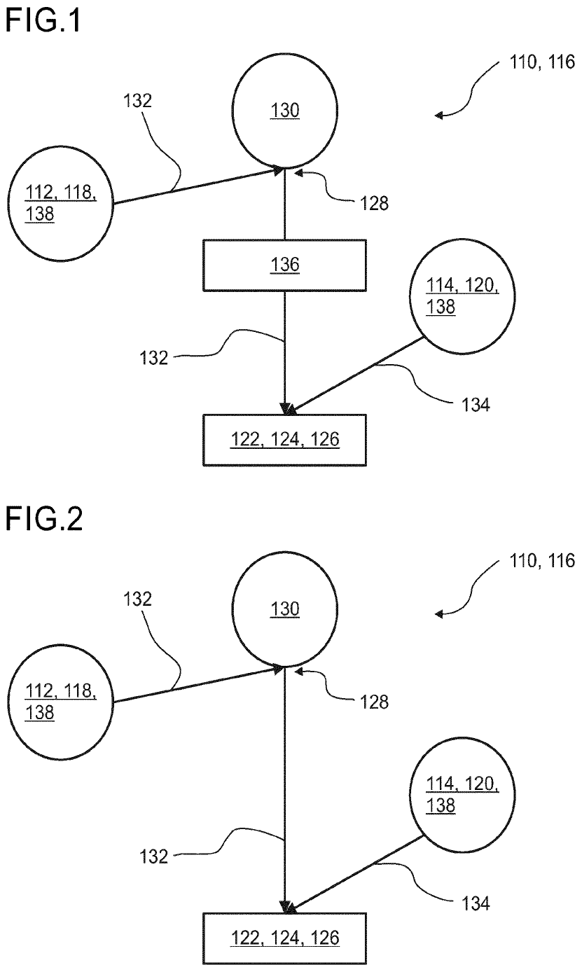

FIG. 1 show a first embodiment of a spectral sensing device 110 in a schematic view. The spectral sensing device 110 comprises at least one first light source 112 configured for emitting light in at least one first optical spectral range and at least one second light source 114 configured for emitting light in at least one second optical spectral range. The spectral sensing device 110, in the example of FIG. 1, may be a near-infrared spectrometer 116, specifically a portable near-infrared spectrometer. For example, the first light source 112 may comprise at least one incandescent lamp 118 and the second light source 114 may comprise at least one light emitting diode (LED) 120. Thus, the first optical spectral range may be different from the second optical spectral range. However, it may also be possible to have the first optical spectral range different from the second optical range by using a first-colored LED as the first light source 112 and a second-colored LED as the second light source 114, wherein the first color may be different from the second color. Other combinations or options of the first 112 and second light sources 114 are also feasible.

The spectral sensing device 110 further comprises at least one detector 122 comprising a plurality of sensor elements 124, wherein each of the sensor elements 124 is configured for generating at least one detector signal in response to an illumination of the sensor element 124 by incident light. The plurality of sensor elements 124 may comprise two or more sensor elements 124. For example, the detector 122 may comprise at least one array of sensor elements 124. Each of the sensor elements 124 may comprise at least one photosensitive area which may be adapted for generating an electrical signal depending on the intensity of the incident light, wherein the electrical signal may, in particular, be provided to at least one evaluation unit 126, as will be outlined in further detail below. The photosensitive area as comprised by each of the sensor elements 124 may, especially, be a single, uniform photosensitive area which is configured for receiving the incident light which impinges on the individual sensor element 124.

The spectral sensing device 110 further comprises at least one sample interface 128 configured for allowing light emitted from the first light source 112 to illuminate at least one sample 130. The spectral sensing device 110 further comprises at least one first optical path 132 configured for allowing light emitted from the first light source 112 to propagate to the detector 122 by passing the sample interface 128 at least once. As shown in FIG. 1, the sample interface 128 may be arranged in the first optical path 132. The spectral sensing device 110 further comprises at least one second optical path 134 allowing light emitted from the second light source 114 to propagate to the detector 122 without passing the sample interface 128.

The spectral sensing device 110 may further comprise at least one at least one wavelength-selective element 136 configured for transferring incident light within at least one selected wavelength range onto the detector 122. The wavelength-selective element 136 may comprise, as an example, at least one of a filter, a grating, a prism, a plasmonic filter, a diffractive optical element and a metamaterial. As can be seen in FIG. 1, the wavelength-selective element 136 may be positioned in the first optical path 132, specifically with wavelength-dependent transfer of light in the first optical path 132 at the wavelength-selective element 136, more specifically with wavelength-dependent transfer of light in the first optical path 132 being reflected by the sample 130.

In the spectral sensing device 110, the second light source 114 is positioned to illuminate each of the sensor elements 124 with the entire second optical spectral range. The entire second optical spectral range on each sensor element 124 may, as an example, be obtained by avoiding passing the light emitted by the second light source 114 through the wavelength-selective element 136. In the exemplary embodiment of FIG. 1, the second light source 114 may be positioned to directly illuminate the detector 122. Other options of having the sensor elements 124 illuminated with the entire second optical spectral range will be discussed with respect to the following FIGS. 2 to 4.

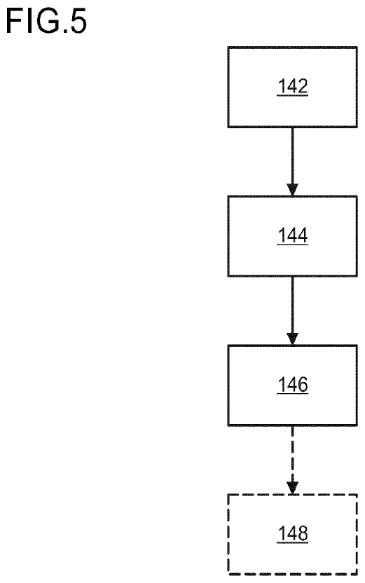

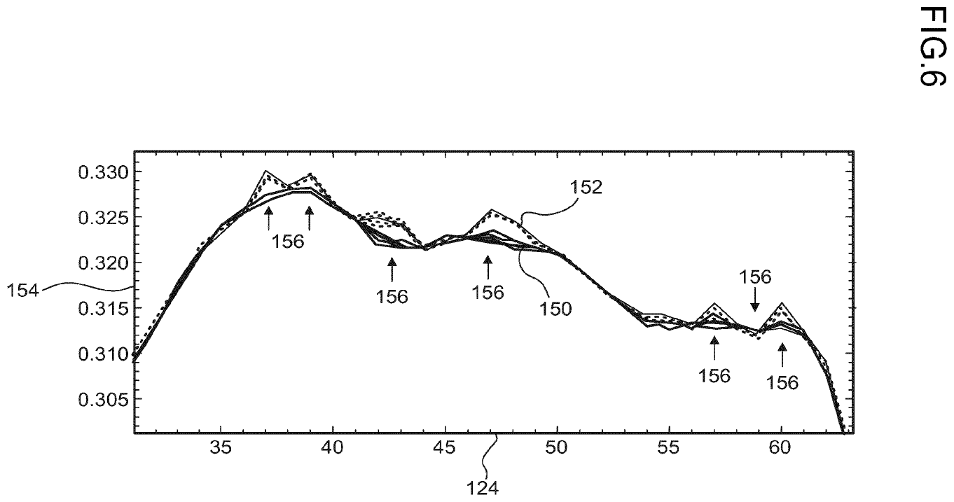

As outlined above, the spectral sensing device 110 may further comprise the at least one evaluation unit 126. The evaluation unit 126 may be configured for determining at least one first detector signal S_{1,i} from illumination in the first optical path 132, specifically at least one first detector signal S_{1,i} for each sensor element i 124, and at least one second detector signal S_{2,i} from illumination in the second optical path 134, specifically at least one second detector signal S_{2,i} for each sensor element i 124. The evaluation unit 126 may further be configured for determining at least one relative time-corrected detector signal S_{1,i,corr} and/or at least one absolute timecorrected detector signal S_{1,i,corr},t-corr by using the first detector signal S_{1,i} and the second detector signal S_{2,i}, specifically by performing the method according to the present invention, such as according to the embodiment disclosed in FIG. 5 and/or according to any other embodiment disclosed herein.

The first light source 112 and the second light source 114 may be configured for emitting light at the same time, specifically simultaneously, or subsequently in time, wherein at least one of the first light source 112 and the second light source 114 may be modulated in time. Specifically, the spectral sensing device 110 may further comprise at least one driving unit 138 for electrically driving at least one of the first light source 112 and the second light source 114. As can be seen in FIG. 1, the driving unit 138 may be comprised by the respective light source 112, 114. As an example, both the first light source 112 and the second light source 114 may be modulated in time with at least one first modulation frequency and at least one second modulation frequency, respectively. The first modulation frequency may be different from the second modulation frequency. The evaluation device 126 may be configured for determining the first detector signal and the second detector signal by demodulation, e.g. using a Fourier transformation.

FIGS. 2 to 4 show different embodiment of the spectral sensing device 110 in a schematic view. The embodiments of the spectral sensing device 110 of FIGS. 2 to 4 widely correspond to the embodiment of the spectral sensing device 110 of FIG. 1. Thus, for a detailed description of the embodiments of FIGS. 2 to 4, reference is made to the description of FIG. 1. In FIG. 2, the spectral sensing device 110 may not comprise the wavelength-selective element 136. For the spectral sensing device 110 according to the present invention, the wavelengthselective element 136 may be an optional element. Further, as can be seen in FIG. 2, the second light source 114 may be positioned to directly illuminate the detector 122.

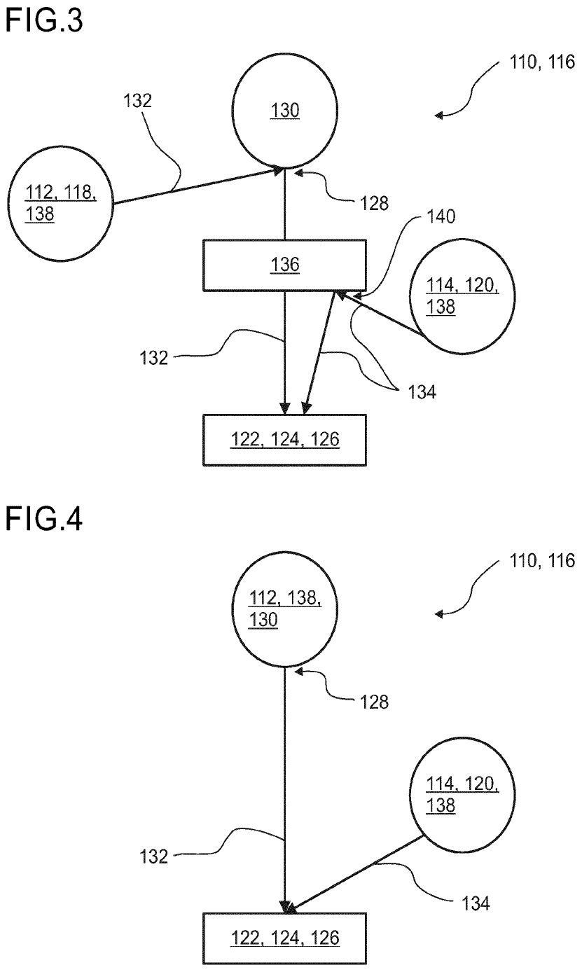

FIG. 3 shows an embodiment of the spectral sensing device 110 comprising the wavelengthselective element 136. As can be seen in FIG. 3, the second optical path 134 may comprise at least one reflection 138 at the wavelength-selective element 136, specifically without wavelength-dependent transfer of light in the second optical path 134 at the wavelength-selective element 136. For example, the second light source 114 may be positioned to illuminate a rear side of the wavelength-selective element 136, wherein light incident on the rear side of the wavelength-selective element 136 may be reflected to the detector 122, specifically without wavelength-dependent transfer at the wavelength-selective element 136.

In FIG. 4, the first light source 112 may be at least partially identical with and/or embodied by the sample 130. For example, the first light source 112 and the sample 130 to be investigated may be or may comprise a thermal emitter, a fluorescent emitter, a phosphorescent emitter, a gas discharge lamp, a laser and/or a light emitting diode. Further, similar to the embodiment of FIG. 2, the spectral sensing device 110 of FIG. 4 may not comprise the wavelength-selective element 136. The second light source 114 may be positioned to directly illuminate the detector 122.

FIG. 5 show a flow chart of an embodiment of a method of determining at least one relative time-corrected detector signal of at least one sample 130. The method comprises using at least one spectral sensing device 110 according to the present invention, such as according to any one of the embodiments of FIGS. 1 to 4 and/or according to any other embodiment disclosed herein. Thus, for a detailed description of the spectral sensing device 110, reference is made to the description of FIGS. 1 to 4.

The method comprises the following steps which, as an example, may be performed in the given order. It shall be noted, however, that a different order is also possible. Further, it is also possible to perform one, more than one or even all of the method steps once or repeatedly. Furthe, it is possible to perform two or more of the method steps simultaneously or in a timely overlapping fashion. The method may comprise further method steps which are not listed.

The method further comprises:
I. (denoted by reference number 142) illuminating the detector 122 via the first optical path 132 using the first light source 112 to obtain at least one first detector signal S_{1,i}, specifically at least one first detector signal S_{1,i} for each sensor element i 124, wherein the sample 130 is applied to the sample interface 128;
II. (denoted by reference number 144) illuminating the detector 122 via the second optical path 134 using the second light source 114 to obtain at least one second detector signal S_{2,i}, specifically at least one second detector signal S_{2,i} for each sensor element i 124; and
III. (denoted by reference number 146) determining the relative time-corrected detector signal by using the first detector signal S_{1,i} and the second detector signal S_{2,i}.

The relative time-corrected detector signal S_{1,i,corr} may specifically be determined according to:

S_{1,i,corr}=S_{1,i}/S_{2,i}.

The first detector signal S_{1,i} may be proportional to an intensity of the first light source I_{1,i} 112 on sensor element i 124 with S_{1,i}=αᵢ (t)I_{1,i}. Similarly, the second detector signal S_{2,i} may be proportional to an intensity of the second light source I_{2,i} 114 on sensor element i 124 with S_{2,i}=αᵢ(t)I_{2,i}. αᵢ may denote a responsivity, specifically a sensitivity, of the sensor element i 124. The relative time-corrected detector signal S_{1,i,corr}=S_{1,i}/S_{2,i}=I_{1,i}/I_{2,i} may specifically be a constant with no time-dependence for each sensor element i 124.

The method may, optionally, further comprise determining at least one factorial drift factor γ (denoted by reference number 148) according to:

$$γ = \frac{1}{N} {\sum }_{i = 1}^{N} {S}_{2 , i} ( t ) / {S}_{2 , i} ( {t}_{0} ) ,$$

wherein N may be a total number of the sensor elements 124, wherein I_{2,i}(t)=β(t)*I_{2,i}(t₀), with β(t₀)=1 at a starting point in time to, and determining at least one absolute time-corrected detector signal S_{1,i,corr,t-corr} according to:

$${S}_{1 , i , corr , t - corr} = \frac{{S}_{1 , i , corr}}{γ} .$$

Further, as outlined above, the spectral sensing device 110 may comprise the at least one evaluation unit 126. The method may comprise determining the at least one first detector signal S_{1,i} from illumination in the first optical path 132, specifically at least one first detector signal S_{1,i} for each sensor element i 124, and the at least one second detector signal S_{2,i} from illumination in the second optical path 134, specifically at least one second detector signal S_{2,i} for each sensor element i 124, by using the evaluation unit 126. The method may comprise, specifically in steps. I and II., emitting light using the first light source 112 and the second light source 114 at the same time, specifically simultaneously, or subsequently in time. For example, the spectral sensing device 110 may further comprise the at least one driving unit 138 for electrically driving at least one of the first light source 112 and the second light source 114. The modulating may comprise using the driving unit 138. The method may comprise modulating at least one of the first light source 112 and the second light source 114 in time. Specifically, the method may comprise modulating the first light source 112 in time with at least one first modulation frequency and modulating the second light source 114 in time with at least one second modulation frequency. The first modulation frequency may be different from the second modulation frequency. The method may comprise determining the first detector signal and the second detector signal by demodulation by using the evaluation unit 126.

FIG. 6 shows a diagram comparing relative time-corrected detector signals 150 with uncorrected detector signals 152. Specifically, the diagram of FIG. 6 shows a signal intensity 154 in a.u. as a function of the sensor element i 124. The relative time-corrected detector signals 150 may be obtained by performing the method according to the present invention, such as according to the embodiment shown in FIG. 5. The uncorrected detector signals 152 may specifically be uncorrected first detector signals. As highlighted in FIG. 6 by reference number 156, the uncorrected detector signals 152 may show artefacts, e.g. due to temporal variation of the sensitivity of the sensor elements 124 and/or due to relative changes of the read-out electronics. The artefacts can be removed by using the spectral sensing device 110 and performing the method according to the present invention, thereby obtaining the relative time-corrected detector signals 150. As shown in FIG. 6, the relative time-corrected detector signals 150 may not comprise artefacts. Thus, the spectral sensing device 110 and the method according to the present invention may allow correcting or compensating artefacts that do not carry any information about the sample 130.

### LIST OF REFERENCE NUMBERS

110 spectral sensing device
112 first light source
114 second light source
116 near-infrared spectrometer
118 incandescent lamp
120 LED
122 detector
124 sensor element
126 evaluation unit
128 sample interface
130 sample
132 first optical path
134 second optical path
136 wavelength-selective element
138 driving unit
140 reflection
142 illuminating the detector via the first optical path
144 illuminating the detector via the second optical path
146 determining the relative time-corrected detector signal
148 determining the factorial drift factor and the absolute time-corrected detector signal
150 relative time-corrected detector signals
152 uncorrected detector signals
154 signal intensity
156 artefacts

1. A spectral sensing device comprising:
at least one first light source configured for emitting light in at least one first optical spectral range and at least one second light source configured for emitting light in at least one second optical spectral range;
at least one detector comprising a plurality of sensor elements, wherein each of the sensor elements is configured for generating at least one detector signal in response to an illumination of the sensor element by incident light;
at least one sample interface configured for allowing light emitted from the first light source to illuminate at least one sample;
at least one first optical path configured for allowing light emitted from the first light source to propagate to the detector by passing the sample interface at least once; and
at least one second optical path allowing light emitted from the second light source to propagate to the detector without passing the sample interface,
wherein the second light source is positioned to illuminate each of the sensor elements with the entire second optical spectral range.

2. The spectral sensing device according to claim 1, wherein the second light source is configured such that an intensity incident on each of the sensor elements has the same scaling factor with time, wherein the second light source is configured to illuminate each sensor element with different spatial intensity distributions, wherein a relative spatial intensity distribution between all sensor elements is constant in time.

3. The spectral sensing device according to claim 1, wherein the spectral sensing device is a near-infrared spectrometer.

4. The spectral sensing device according to claim 1, further comprising at least one evaluation unit, wherein the evaluation unit is configured for determining at least one first detector signal S_{1,i} from illumination in the first optical path, and at least one second detector signal S_{2,i} from illumination in the second optical path, wherein the first light source and the second light source are configured for emitting light at the same time, or subsequently in time, wherein at least one of the first light source and the second light source is modulated in time.

5. The spectral sensing device according to claim 1, wherein the spectral sensing device comprises at least one wavelength-selective element configured for transferring incident light within at least one selected wavelength range onto the detector.

6. The spectral sensing device according to claim 1, wherein the second optical path comprises at least one reflection at the wavelength-selective element, and/or wherein the second light source is positioned to directly illuminate the detector.

7. The spectral sensing device according to claim 1, wherein the detector and the second light source are comprised by at least one housing, the housing comprising at least one window element being optically transparent at least in the first optical spectral range, wherein the window element is positioned in the first optical path wherein the second light source is positioned to illuminate the housing such that light emitted by the second light source is reflected by the housing and propagates to the detector.

8. The spectral sensing device according to claim 1, wherein the detector and the second light source are positioned in at least one stack, wherein, in the stack, the second light source is positioned on a rear side of the detector, wherein the second light source is positioned to emit light though the rear side of the detector towards the housing.

9. A method of determining at least one relative time-corrected detector signal of at least one sample, the method comprising using at least one spectral sensing device according to claim 1, the method further comprising:
I. illuminating the detector via the first optical path using the first light source to obtain at least one first detector signal S_{1,i}, wherein the sample is applied to the sample interface;
II. illuminating the detector via the second optical path (134) using the second light source to obtain at least one second detector signal S_{2,i}, and
III. determining the relative time-corrected detector signal by using the first detector signal S_{1,i} and the second detector signal S_{2,i}.

10. The method according to claim 9, wherein the relative time-corrected detector signal S_{1,i,corr} is determined according to:
S_{1,i,corr}=S_{1,i}/S_{2,i}.

11. The method according to claim 10, wherein the first detector signal S_{1,i} is proportional to an intensity of the first light source I_{1,i} (112) on sensor element i with S_{1,i}=αᵢ(t)I_{1,i}, wherein the second detector signal S_{2,i} is proportional to an intensity of the second light source I_{2,i} on sensor element i with S_{2,i}=αᵢ(t)I_{2,i}, wherein αᵢ denotes a responsivity, of the sensor element i.

12. The method according to claim 11, further comprising determining at least one factorial drift factor γ according to:
$$γ = \frac{1}{N} {\sum }_{i = 1}^{N} {S}_{2 , i} ( t ) / {S}_{2 , i} ( {t}_{0} ) ,$$
wherein N is a total number of the sensor elements, wherein I_{2,i}(t)=β(t)*I_{2,i}(t₀), with β(t₀)=1 at a starting point in time to, further comprising determining at least one absolute time-corrected detector signal S_{1,i,corr,t-corr} according to:
$${S}_{1 , i , corr , t - corr} = \frac{{S}_{1 , i , corr}}{γ} .$$

13. The method according to claim 9, the spectral sensing device further comprising at least one evaluation unit, wherein the method comprises determining the at least one first detector signal S_{1,i} from illumination in the first optical path, and the at least one second detector signal S_{2,i} from illumination in the second optical path, by using the evaluation unit, wherein the method comprises emitting light using the first light source and the second light source at the same time, or subsequently in time, wherein the method comprises modulating at least one of the first light source and the second light source in time.

14. A computer program comprising instructions which, when the computer program is executed by a spectral sensing device according to claim 13, causes the spectral sensing device to perform a method of determining at least one relative time-corrected detector signal of at least one sample.

15. A computer-readable storage medium, comprising instructions which, when the instructions are executed by a spectral sensing device according to claim 13, causes the spectral sensing device to perform a method of determining at least one relative time-corrected detector signal of at least one sample.
